(19) United States
(12) Patent Application Publication
(10) Pub. No.: US 2016/0087370 A1
(43) Pub. Date: Mar. 24, 2016

(54) ELECTRICAL CONNECTION SYSTEMS

(71) Applicants: TOMTOM INTERNATIONAL B.V., Amsterdam, OT (NL); TOMTOM SOFTWARE LTD., London (GB)

(72) Inventors: Samuel Mark Broadbent, Amsterdam, OT (NL); Mark Lee Dempsey, Beckenham (GB); Nicholas Alexander Evans, Amsterdam, OT (NL); Martin Riddiford, London (GB)

(73) Assignees: TOMTOM INTERNATIONAL B.V., Amsterdam, OT (NL); TOMTOM SOFTWARE LTD., London (GB)

(21) Appl. No.: 14/785,356

(22) PCT Filed: Apr. 17, 2014
(86) PCT No.: PCT/EP2014/057980

§ 371 Date: Oct. 19, 2015

(30) Foreign Application Priority Data
Apr. 17, 2013 (GB) 1306993.5

(51) Int. Cl. H01R 13/502; H01R 12/70

(52) U.S. Cl. CPC H01R 13/502; H01R 12/7005

(57) ABSTRACT

An electrical connector assembly 202 to support and form an electrical connection with a portable electronic device 201 is disclosed comprising a power connector 208 having one or more electrical contacts to deliver electrical power to the portable electronic device 201 and a protruding support 204 for the electronic device that is insertable into a recess 223 in a connector receiving assembly 206 of the device in order to engage the power connector 208 with a corresponding device connector 222. An electrical connector receiving assembly 206 of or for an electronic device is further disclosed comprising a device connector 222 having one or more electrical contacts arranged to receive electrical power when the device connector is engaged with a corresponding power connector 208 provided by an electrical connector assembly 202, and a recess 223 that houses the device connector 222 and is arranged to receive the electrical connector assembly 202 in order to engage the device connector with the corresponding power connector.

### FIELD OF INVENTION

The present invention relates to electrical connection systems for portable electronic devices. Some embodiments of the invention relate to a mounting apparatus and to an electrical connector assembly to support and form an electrical connection with a portable electronic device. Some other embodiments relate to a corresponding connector receiving assembly of or for an electronic device.

### BACKGROUND OF THE INVENTION

Various measures have been taken to mount portable electronic devices, such as portable navigation devices (PNDs) and other electronic equipment, for use in vehicles. For example, it is known to mount such electronic equipment in cradles or holders located on the vehicle dashboard or attached to the windscreen. These mounting solutions can be permanent, e.g. where the cradle is screwed or glued to the dashboard, or temporary, e.g. where the cradle is held in place using a suction cup. There is a growing number of portable, e.g. touch screen, electronic devices which are capable of providing in-car functions such as navigation, route planning, traffic updates, etc. These are often purchased for reasons other than navigation, e.g. digital music players, games consoles, smart phones, tablet computers, etc. These devices, when used as PNDs, tend to suffer from a limited battery life and thereby necessitate the use of an in-vehicle charging means, such as a cigarette lighter adapter and charging cable, in addition to suitable mounting.

Some mounting solutions are passive, and are designed to simply hold an electronic device in a fixed position. Accordingly with such mounts the user typically needs to first locate their device in the mount and then separately attach a power cable, e.g. connected to a cigarette lighter adapter, to the device. Other mounting solutions, typically permanent mounts, actively provide an electrical connection and thus a user needs to only locate their device in the cradle, and in so doing connects the device to the mount's electrical connector. There are, however, a number of drawbacks with such mounts. For example, the cradles are often large and potentially interfere with a driver's view or operation of other controls in the vehicle and/or have an ugly appearance when the electronic equipment is removed. Edges or corners might also present a hazard to the vehicle's occupants in the event of an accident. It also can be difficult for a user to insert and/or remove the electronic device from the mount, especially when an electrical connection is to be made, often requiring a number of actions to be performed in a specific order.

There remains a need for improved electrical connection systems for portable electronic devices, and in particular portable navigation devices, that mitigate or reduce some of the above problems.

### SUMMARY OF THE INVENTION

According to a first aspect of the present invention there is provided an electrical connector assembly to support and form an electrical connection with a portable electronic device, the electrical connector assembly comprising: a power connector having one or more electrical contacts to deliver electrical power to a portable electronic device when the power connector is engaged with a corresponding device connector in an electrical connector receiving assembly of the electronic device; and a protruding support for the electronic device that is insertable into a recess in the connector receiving assembly in order to engage the power connector with the corresponding device connector, the support comprising a support surface extending in a plane substantially parallel to the electrical contact(s) of the power connector, and a pair of side walls each having an inner surface extending in a plane substantially transverse to the support surface; wherein at least one of the support surface and the inner surfaces of the side walls is/are spaced from the power connector and formed with part of a latch arrangement that receives a corresponding part of the connector receiving assembly to releasably retain the protruding support within the connector receiving assembly.

The present invention relates to an electrical connector assembly that does not only form an electrical connection with a portable electronic device, but also acts to support the device by providing a protruding support that is insertable into a recess in a connector receiving assembly of the device. This may be contrasted with a typical electrical connector for a portable electronic device such as a portable music player, where the device simply locates over a protruding power connector without any additional mechanical support being provided. While it may be suitable to mount a portable electronic device directly onto a power connector when the device will be stationery in a generally vertical position, for example when mounting a portable music player to a speaker dock, this is not well suited to an in-vehicle environment. When mounting a portable electronic device such as a portable navigation device (PND) to an electrical connector in a vehicle, the device is likely to jump around due to the motion of the vehicle. Furthermore, when mounting a portable navigation device it can be particularly important that the device can be angled towards a user to be able to view the screen and for the device to be positionable at multiple different angles, e.g. to suit different drivers, lighting conditions, etc. This means that a portable navigation device is ideally not always mounted in the same vertical position. It is desirable to be able to support the device at a range of different positions and/or angles. The protruding support of the electrical connector assembly solves these problems by being inserted into a recess in the device's connector receiving assembly so as to provide for mechanical engagement in addition to an electrical connection with the power connector.

It will be appreciated that the protruding support provides surfaces extending in at least two planes surrounding the power connector so that the weight of the portable electronic device can be supported not only when it is vertical but also when it is tilted through a range of angles. This means that the electronic device can be tilted forwards, backwards and/or side to side with its weight being supported by one or more of the surfaces of the protruding support. This means that the power connector can maintain a firm electrical connection with the electronic device without being compromised by a turning moment that would tend to pull the device out of electrical connection if it were not supported by the surrounding surfaces.

It is ensured that an electronic device is securely mounted on the electrical connector assembly, regardless of the angle of the device, by the latch arrangement that releasably retains the protruding support within the connector receiving assembly. This means that the electronic device may even hang down from the protruding support, as the support is retained within the connector receiving assembly by the latch arrangement.

It will be appreciated that when a protruding support of an electrical connector assembly is inserted into a recess in a corresponding connector receiving assembly of an electronic device, the weight of the device may be adequately supported without a bulky support frame or the like extending around the outside of the device. Such an electrical connector assembly can therefore provide for a robust electrical connection and a strong mechanical mounting yet one that has a slim profile. Furthermore, the support and latch arrangement can allow a user to locate the assembly, and to remove the device, with minimal effort, e.g. using only one hand.

In order to assist in supporting the device, the protruding support of the electrical connector assembly preferably protrudes from the assembly beyond the power connector. The electrical connector assembly may optionally include several further features to help enhance its ability to support the weight of a portable electronic device regardless of the angle at which it is mounted, as will be described below.

Preferably the inner surfaces of the side walls are each provided with a longitudinal groove extending substantially parallel to the electrical contact(s) of the power connector. Such grooves may assist in guiding a connector receiving assembly and its device connector into engagement with the power connector. A close mating engagement between the longitudinal grooves and a part of the connector receiving assembly can also help to ensure that the weight of the electronic device is supported all the way along the protruding support. The side walls may be integrally formed with the support surface. Alternatively, the side walls may be formed separately and mounted to the support surface by any suitable means, such as an adhesive or a soldered joint. In either case, it is preferable that the side walls are connected at a periphery of the support surface to form a substantially U-shaped or semi-circular support surrounding the power connector. It can be helpful for the U-shaped or semi-circular support not to extend opposite the support surface so as to provide greater freedom in locating a corresponding connector receiving assembly over the protruding support, e.g. across a range of approach angles. However it is also envisaged that the protruding support may comprise a pair of opposed support surfaces extending in a plane substantially parallel to the electrical contact(s) of the power connector to form a generally rectangular, circular or elliptical support surrounding the power connector. While the one or more support surfaces may extend in-plane so as to be substantially parallel to the electrical contacts of the power connector, in some embodiments at least one support surface extends out of plane at an angle to the electrical contacts of the power connector, e.g. so as to provide for tapered entry towards the power connector. The angle of taper may be relatively small, e.g. less than 10° and preferably less than 5°.

It is helpful for the protruding support of the electrical connector assembly to be able to guide itself into the recess provided in the corresponding connector receiving assembly of an electronic device. In addition to the surfaces discussed above, the protruding support may further include a surface in a plane substantially transverse to the electrical contact(s) of the power connector that is a curved surface. This curved surface may be provided at an extremity of the protruding support. As the protruding support is inserted into a recess, this curved surface can help to guide the support into an aligned position so as to ensure proper engagement between the power connector and a corresponding device connector. In addition, or alternatively, each side wall of the protruding support may have an outer surface that is shaped to guide the support as it is inserted into the recess. Preferably each side wall has an outer surface that is curved to assist in alignment of the protruding support. The various curved surface(s) of the protruding support act to achieve correct alignment of the connector assembly when the support is inserted into a recess in the connector receiving assembly of an electronic device.

In addition, or alternatively, the protruding support may have an outer surface opposed to the supporting surface that is shaped to guide insertion of the protruding support. In one set of examples the outer surface may be circular. The outer surface is preferably flat and arranged in a plane substantially parallel to the electrical contact(s) of the power connector, e.g. so that the protruding support is guided for insertion in a direction aligned with the power connector. However, in at least some embodiments the protruding support may not be inserted into a recess that surrounds the support on all sides, and the outer surface that is opposed to the supporting surface may be exposed while the other surfaces are inserted into the recess. It is therefore envisaged that the outer surface of the protruding support may not necessarily be shaped to guide alignment of the electrical connector assembly, and may instead have any suitable shape that would not interfere with use of the electronic device when it is mounted to the electrical connector assembly.

Although it is described above that the protruding support is insertable into a recess in a connecting receiving assembly, this is not essential to all aspects of the invention. A similar supporting function may alternatively be achieved by inserting part of the connector receiving assembly into the support, and/or by engaging the support on or against the connector receiving assembly. It will be understood that the protruding support may be engaged in, over, on or against a connector receiving assembly in any suitable manner as long as a mechanical connection is achieved in addition to the electrical connection formed between the power connector and device connector.

Thus according to a further aspect of the invention there is provided an electrical connector assembly to support and form an electrical connection with an electronic device, the electrical connector assembly comprising: a power connector having one or more electrical contacts to deliver electrical power to an electronic device when the power connector is engaged with the corresponding device connector in an electrical connector receiving assembly of an electronic device; and a protruding support that engages with a connector receiving assembly in order to engage the power connector with the corresponding device connector; wherein the protruding support provides part of a latch arrangement that receives a corresponding part of the connector receiving assembly to releasably retain the support in engagement with the connector receiving assembly.

There will now be described further features that may be applicable to embodiments of either aspect of the invention outlined above.

The power connector may be of any suitable and desired form, but in a preferred set of embodiments the power connector comprises a USB connector, such as a micro- or mini-USB connector. The power connector may comprise either a male (plug) connector or a female (socket) connector as desired. In a preferred set of embodiments the power connector comprises a male connector plug that is insertable into a corresponding female connector socket provided in the recess in a corresponding connector receiving assembly.

It will be understood that the power connector is preferably spaced from at least one or the support surface and inner surfaces of the side walls of the protruding support, so as to make space to receive a corresponding part of the latch arrangement provided by the connector receiving assembly so that the protruding support is held in engagement until released. In one set of embodiments the power connector is spaced from the inner surfaces of the side walls, e.g. so as to provide space for the latch arrangement on either side of the power connector. One or both of the inner surfaces of the side walls may be formed with part of the latch arrangement. It may be preferable for both inner surfaces of the side walls to be formed with part of the latch arrangement so as to ensure that the connector receiving assembly is engaged fully with the protruding support and cannot move out of engagement even if it is rotated or angled to one side. Alternatively, or in addition, the power connector may be spaced from the support surface between the side walls. The support surface may optionally be formed with part of the latch arrangement. In embodiments where the power connector comprises a male connector plug, it is preferable for the support surface and the inner surfaces of both side walls to be spaced from the power connector so as to receive a corresponding female connector socket without interference from the surrounding surfaces. In other embodiments, for example where the power connector comprises a female connector socket, the power connector may rest on the support surface rather than being spaced therefrom.

The electrical contact(s) may form an electrical connection that transmits data and/or power between the power connector and corresponding device connector. The one or more electrical contacts of the power connector are preferably connected to an electrical cable, e.g. by means of soldered joint. A flexible electrical cable of standard design may be used. The electrical cable can be attached to the electrical connector assembly in any suitable and desired manner. For example, the power connector may be integrally moulded or over-moulded with the electrical cable. Preferably the electrical cable is coupled to the power connector so as to extend in a direction away from the protruding support. This can help to keep the cable clear of the area where an electronic device is to be docked onto the electrical connector assembly.

The power connector (and optionally any electrical cable coupled thereto) may be co-located with the protruding support or fixedly attached to the protruding support in the electrical connector assembly. This may be facilitated by attaching the connector assembly to a mount comprising a hollow body. An electrical cable may pass through the hollow body to locate the power connector in relation to the protruding support.

Any suitable latch arrangement may be employed that enables the protruding support to be releasably retained within the connector receiving assembly. For example, a surface of the protruding support may be formed with a movable lever or other type of mechanical latch that engages with a corresponding latch keeper in the connector receiving assembly to retain the support within the recess. Such a lever or other mechanical latch may be released by a user-operated actuator. However, providing an actuator to release the latch before the electronic device can be disconnected from the electrical connector assembly may require two-handed operation or at least two different steps to be performed.

In a preferred set of embodiments the latch arrangement provides a retaining force that can be overcome by separating the connector receiving assembly from the protruding support. Thus the latch arrangement can be released simply through the action of separating the electronic device from the electrical connector assembly, which facilitates single-handed removal of the device. The retaining force may be provided by one or more of a frictional engagement, a magnetic interaction, and/or or a resilient connection. A resilient latch arrangement may be preferred, alone or in combination with other latching arrangements, as this may provide a retaining force that is strong enough for the device to be firmly connected to the electrical connector assembly across a range of angles, while also being easy enough to be overcome by a user simply pulling the device away from the protruding support.

In one set of embodiments, at least one surface of the protruding support is formed with part of a latch arrangement comprising a resilient member or means for retaining a resilient member provided by the connector receiving assembly. However, if a surface of the protruding support is formed with a resilient member of the latch arrangement then it is likely to be exposed on the outside of the electrical connector assembly and potentially at risk of being damaged by external influences. It may therefore be preferred for a surface of the protruding support to be formed with a retaining profile for a resilient member provided by the connector receiving assembly. The resilient member may then be protected within the recess of the connector receiving assembly. The retaining profile may take the form of a notch or projection that is arranged to releasably engage with the corresponding resilient member.

As is mentioned above, it may be preferable for the latch arrangement to be symmetrical and provided on both sides of the power connector. It is therefore preferred that both inner surfaces of the pair of side walls are formed with retaining profiles for resilient members that are received either side of the power connector. When the protruding support is inserted into a recess in a corresponding connector receiving assembly, resilient members of the latch arrangement may engage in the retaining profiles provided by the protruding support so that an electronic device is mechanically attached to the electrical connector assembly until the latch arrangement is released, e.g. by pulling the connector receiving assembly away from the protruding support so that the resilient members are forced to deform and disengage from the retaining profiles.

The above described latch arrangement acts to releasably retain the protruding support when inserted into a recess in a corresponding electrical connector receiving assembly.

According to a second aspect of the present invention there is provided an electrical connector receiving assembly of or for an electronic device, the electrical connector receiving assembly comprising: a device connector having one or more electrical contacts arranged to receive electrical power when the device connector is engaged with a corresponding power connector provided by an electrical connector assembly; and a recess that houses the device connector and is arranged to receive the electrical connector assembly in order to engage the device connector with the corresponding power connector to form an electrical connection for the electronic device; wherein part of a latch arrangement is provided at an inner surface of the recess so as to be insertable into a corresponding space in the electrical connector assembly to thereby releasably retain the electrical connector assembly in the recess.

An electrical connector receiving assembly according to this aspect of the invention takes advantage of a recess housing the device connector that has part of a latch arrangement provided at an inner surface of the recess so that, in addition to an electrical connection being formed, there is also a mechanical connection with a corresponding electrical connector assembly. In a preferred set of embodiments the recess defines a channel extending in a plane substantially parallel to the electrical contact(s) of the device connector. Such a channel may be arranged to receive the protruding support of a corresponding electrical connector assembly as is described herein above. The channel may also extend in another transverse plane so as to surround the device connector on at least two sides. Preferably the recess defines a generally U-shaped or semi-circular channel surrounding the device connector. Such a channel may suitably receive a generally U-shaped or semi-circular protruding support as described above. Furthermore, the channel may be provided with one or more curved side walls that help to locate the recess over a protruding support that also has curved surfaces. This can ensure proper alignment of the two electrical connector assemblies so that a robust electrical connection is provided. The recess may therefore be defined by a generally flat wall extending substantially parallel to the device connector and a pair of opposed side walls that are preferably curved.

In one set of embodiments, the recess is preferably shaped to guide the electrical connector assembly into a correct alignment with the connector receiving assembly. For example, an inner surface of the recess is preferably substantially flat, e.g. to form a guide surface that co-operates with a corresponding flat outer surface of the protruding support. Similarly, the side surfaces of the recess may be partially curved or concave, e.g. to form a guiding surface that co-operates with the curved side walls of the protruding support.

As is already discussed above, the latch arrangement may take any suitable form, including one or more of mechanical engagement, frictional engagement, magnetic interaction and/or resilient connection. In a preferred set of embodiments the part of the latch arrangement in the electrical connector receiving assembly comprises at least one resilient member. The resilient member(s) is conveniently protected within the recess so as to be less likely to suffer accidental damage. The one or more resilient members may be arranged to releasably engage with a retaining profile provided on a surface of the protruding support of a corresponding electrical connector assembly, as is described above. The resilient member, such as a spring member, may be arranged to extend from an inner surface of the recess into the recess when it is in a relaxed position. When a protruding support is inserted into the recess, the resilient member may be pressed towards the inner surface of the recess before engaging into a retaining profile on a surface of the support which allows it to move back into its relaxed position. In order to release the latch arrangement, the electrical connector receiving assembly may be pulled away from the protruding support with sufficient force to overcome the spring bias and push the resilient member back towards an inner surface of the recess so that the protruding support can be released from the recess. Preferably a pair of resilient members are provided at inner surfaces of the recess on either side of the device connector. The two resilient members may be independent or they may be connected, e.g. as part of the same V-shaped spring member.

The latch arrangement may comprise a single resilient member or a plurality of resilient members as desired. The resilient member(s) can be of any suitable form, and may for example comprise one or more springs. A single resilient member may be formed so as to comprise two or more contact portions, e.g. so that at least one contact portion is provided either side of the device connector. In one example, the resilient member may comprise a V-shaped leaf spring. Alternatively, the latch arrangement may comprise one or more helical springs.

The device connector may also be of any suitable type as desired, but is preferably a USB connector, such as a micro- or mini-USB connector. As was discussed above, either the device connector or the power connector may be a male connector or a female connector, or vice versa, as desired. Thus, in a preferred embodiment, the device connector comprises a female (socket) connector arranged to engage with a corresponding male (plug) connector provided by the electrical connector assembly.

The connector receiving assembly is preferably mounted to or integrated with a portable electronic device, e.g. with the recess of the receiving assembly being an opening in the external housing of the device. The present invention extends to an electrical connection system comprising a portable electronic device provided with an electrical connection to an electrical connector assembly by an electrical connector receiving assembly as described above. The electrical connector receiving assembly may be integrated with the electronic device, or it may be a separate assembly which is fitted or retro-fitted to the device. Such an electrical connection system allows for electrical communication, e.g. power and/or data between a power source and a portable electronic device. It is an advantage of such a system that the portable electronic device can conveniently be docked and undocked using a single-handed operation. Furthermore, the device may be securely supported even if it is oriented at an angle, e.g. for ease of viewing, that would otherwise cause the device to separate the electrical connection.

The connector receiving assembly can be attached to the portable electronic device in any suitable and desired manner. For example, the receiving assembly is preferably attached or integrally formed with the housing or casing of the electronic device. Preferably the one or more electrical contacts are in electrical contact with circuitry in the electronic device for power and/or data communication. For example, the electrical contacts of the device connector are connected to a printed circuit board (PCB) of the electronic device.

Such an electrical connection system may be used to connect a portable electronic device, preferably a portable navigation device (PND), to a power connector provided by a connector assembly that is attached to a mounting apparatus in a vehicle such as a car, motorbike, bicycle or boat for example. The power connector and related electrical connector assembly may be directly or indirectly provided by the mounting apparatus. In at least some embodiments the electrical connector assembly may be integrally formed with the mounting apparatus, which may itself optionally be integrated with a dashboard of a vehicle.

In preferred embodiments, the portable electronic device is preferably a touch screen device. The portable electronic device may comprise a mobile phone, smart phone, PDA, portable audio system (e.g. radio player, MP3 player), multi-media player, games console, tablet computer, portable personal computer or the like.

Some variants of the connector assemblies of an electrical connection system for a portable electronic device will now be described.

According to a fifth aspect of the present invention there is provided an electrical connector assembly insertable into a connector receiving assembly of a potable electronic device to support and form an electrical connection with the portable electronic device, the connector assembly comprising: a base plate having a contact mounting surface; a pair of raised guide surfaces on the base plate, each guide surface having a stop shoulder at an end thereof; and one or more electrical contacts on the contact mounting surface between the pair of raised guide surfaces.

According to a sixth aspect of the present invention there is provided an electrical connector receiving assembly of or for an electronic device for receiving a connector assembly, the connector receiving assembly comprising: a base member having a guide surface; a bridge member disposed above the base member forming an opening therebetween for receiving the connector assembly, the bridge member having a pair of guide surfaces extending into the opening, an abutment surface for restricting movement of the connector into the opening, and a contact mounting surface facing the guide surface of the base member; one or more electrical contacts on the contact mounting surface between the pair of guide surfaces; and a latching member for releasably engaging the connector assembly.

The connector assembly comprises a base plate having a pair of raised guide surfaces and one or more electrical contacts, preferably a plurality of electrical contacts. The contacts are mounted on the base plate such that the contacts at least partially lie in a region of the base plate between the pair of raised surfaces. The base plate of the connector has two opposing faces and an edge region therebetween; one of the opposed faces comprises the electrical contact(s) and raised guide surfaces, and the other face is preferably substantially flat, e.g. to form a guide surface. A stop shoulder is also provided at the end of each raised guide surface.

The connector receiving assembly comprises a base member having a, preferably substantially flat, guide surface and a bridge member disposed above the base member to form an opening. The surface of the bridge member that faces the guide surface of the base member has one or more electrical contacts, preferably a plurality of electrical contacts, mounted thereon. As will be discussed in more detail below, the electrical contacts on the bridge member mate with the electrical contacts on the connector as it is inserted into the opening in the receiving assembly to form an electrical connection between the electronic device and mount for power and/or data transfer.

The connector receiving assembly further comprises a pair of guide surfaces on the bridge member. Each guide surface preferably comprises a raised surface on the bridge member that extends into opening formed between the bridge and base members. Accordingly it will be appreciated that the opening in the receiving assembly comprises: a lower surface—the guide surface of the base member; an intermediate surface—the guide surfaces of the bridge member; and an upper surface—the contact mounting surface of the bridge member.

The bridge member further comprises an abutment surface for restricting movement of the connector assembly into the opening. The abutment surface is preferably substantially perpendicular to the guide surface of the base member, e.g. coplanar with the opening.

In use, a user will insert the connector assembly into the opening in the connector receiving assembly. The substantially flat guide surface of the connector assembly base plate will slide along the guide surface of the receiving assembly base member, and the raised guide surfaces of the connector assembly will cooperate with the guide surfaces of the bridge member such that the connector is positioned correctly in the opening. As the user continues to insert the connector assembly into the opening, the stop shoulders of the connector assembly will eventually contact the abutment surface of the receiving assembly to prevent further movement of the connector assembly. The electrical contacts on the connector assembly will then be correctly aligned with the complementary contacts in the receiving assembly. To maintain the connector assembly in this “inserted” position, the receiving assembly further comprises a latching member that engages with or locks the connector, preferably by mating with the stop shoulders, and which is further configured to be releasable such that user can remove the connector from the receiving assembly.

Such a connection system has a number of advantages. For example, the construction of the connector allows the connector receiving assembly to have a slim profile, thereby allowing the width of the electronic device to be reduced in comparison to conventional devices. For example, the electronic device can have a thickness of as little as 10 mm, or even less.

Furthermore, the guide surfaces and structures of the connector and receiving assemblies allow a user to easily and successfully dock an electronic device to a mount with a single action, e.g. without damaging the electrical contacts, even if the connector is initially misaligned with the opening. In other words, the guide surfaces and abutment surface function as alignment features to correctly position the connector as it is pushed into the opening. A user therefore no longer needs to perform the two separate steps of placing an electronic device in a mount and then additionally connecting a cable to the device to provide power and/or data.

The connector assembly has a first end which is preferably configured to be attached or be integrally formed with a mount, and a second end comprising the base plate which is configured to be inserted into the opening of the receiving assembly. The base plate preferably has a thin, disc-like construction, and accordingly has two opposing faces or surfaces with an edge portion therebetween. For example, the base plate can have a thickness of 2 mm or less, preferably 1 mm or less.

The base plate is preferably formed from a metallic material (e.g. a metal sheet), plastics material or the like. Although those skilled in the art will appreciate that any suitable material can be used for the base plate provided it is sufficiently strong and rigid.

The base plate preferably has a shape to enhance the self-alignment of the connector assembly as it inserted into the opening. In particular, the base plate is curved or convex along at least a portion of its edge. In a preferred embodiment, the front and side edges of the base plate are curved, e.g. such that the base plate has a substantially circular or elliptical profile. By using a base plate with such a curved profile, if the connector assembly is pushed into the opening of the receiving assembly such that one stop shoulder hits abutment surface before the other, then the shape of the connector allows the connector to rotate/move until the other stop shoulder also contacts the abutment surface. It is also contemplated, however, that the profile of the base plate could be stepped, angled or contoured in such a way so as to facilitate a similar effect (i.e. instead of being curved).

The one or more electrical contacts on the contact mounting surface can be of any suitable form. For example, the contacts preferably comprise linear contacts that extend along the contact mounting surface, e.g. such that the contacts have a low profile above the mounting surface. The electrical contacts preferably comprise a first linear (or substantially flat) segment and a second segment having a generally arcuate geometry, e.g. such that the second segment raises above the plane of the base plate. Alternatively, the second segment can have an angular or linear geometry as desired. The arcuate geometry of the second segment allows the contact to be deformed by a corresponding electrical contact in the receiving assembly as the connector is inserted into the opening in the assembly, e.g. thereby wiping dust and other similar debris from the surface of the contact each time the connector is inserted/removed.

The pair of raised guide surfaces on the base plate can also be of any suitable and desired form. For example, the raised guide surfaces can be mounted to the contact mounting surface, e.g. by means of an adhesive or the like. In an preferred embodiment, however, the pair of raised surfaces are integrally formed with the base plate. Preferably the pair of raised surfaces on the base plate extend longitudinally from a front end of the connector, i.e. the end that is inserted into the opening, to a back end of the connector that is attached to a mount.

In a preferred embodiment, the raised guide surfaces comprise a tapered or angled portion. The tapered surface is preferably at the leading edge or face of the guide surface, i.e. the part of the surface that first enters the opening in the receiving assembly. The tapered surface is arranged to cooperate with the pair of guide surfaces on the bridge member such that the connector is pushed into a correct alignment with the electrical contacts of the bridge member. In other words, the tapered surface is a reducing taper, which reduces in height toward the front of the connector. As will be appreciated, this causes the guide surface of the connector base plate to be pushed into contact with the corresponding guide surface of the base member. The pair of raised guide surfaces therefore preferably comprise a tapered section and a linear (or substantially flat) section.

In a preferred embodiment, the height of the raised guide surfaces, and preferably the linear section thereof, is greater than the height of the electrical contacts. Preferably the height refers to the maximum perpendicular height above the surface of the base plate. As will be appreciated this means that the upper surface of the electrical contacts is always below the raised guide surfaces, thereby preventing damage to the electrical contacts as the connector is inserted into the receiving assembly. Accordingly, and wherein the guide surfaces comprise a tapered portion, the electrical contacts are preferably recessed from the front of the guide surfaces such that the upper surface of the electrical contacts is below the top of the raised guide surfaces.

A stop shoulder is provided at the end of each of the pair of raised surfaces. The stop shoulder can be of be of any suitable form as desired. For example, the stop shoulder can be integrally formed with the raised guide surfaces. Therefore, preferably, the pair of raised guide surfaces comprise a tapered section, a linear (or substantially flat) section and a shoulder section. In other embodiments, the stop shoulder can be a separate structure from the raised guide surface.

The stop shoulder preferably has a height greater than the raised guide surface above the surface of the base plate, such that the stop shoulder will eventually contact the abutment surface of the bridge member as the connector is pushed into the opening in the receiving assembly. It will therefore be appreciated that the height of the stop shoulder above the base plate is greater than the perpendicular difference in height between the aforementioned lower surface and intermediate surface of the bridge member.

The upper surface of each stop shoulder is preferably tapered, angled or suitably curved, such that it preferably reduces in height toward the back of the connector. The profile of the stop shoulder upper surface, as will be discussed in more detail below, preferably functions to automatically raise (and therefore release) the latching member of the connector receiving assembly as the connector is pulled out of the receiving assembly. Similarly, the profile of the stop shoulder upper surface preferably functions to automatically raise (and release) the latching member of the connector receiving assembly as the connector is inserted into the receiving assembly, before allowing the latching member to fall (and lock or engage) the connector once it is fully inserted into the receiving assembly.

Although in the above passages, the connector assembly is said to comprise a pair of raised surfaces forming a region therebetween in which is located, at least partially, the one or more electrical contacts, it should be appreciated that there could be more than two raised surfaces as desired. In addition, it should also be recognised that the pair of raised surfaces could, for example, be formed as a single structure bounding the electrical contacts.

The connector assembly, and preferably the base plate, can be formed at least in part from a magnetic material, e.g. a ferromagnetic material such as iron, steel or the like. For example, the connector assembly could be made entirely from the magnetic material, or alternatively the connector assembly may have one or more portions formed of a magnetic material. As will be discussed in more detail below, the connector receiving assembly, and preferably the latching member, preferably comprises a magnet that cooperates with the magnetic material of the connector to control the force needed to insert and/or remove the connector assembly from the receiving assembly, thereby improving the feedback to the user when using the connection system.

As discussed above, the connector assembly is insertable into a receiving assembly (e.g. of a portable electronic device). The connector receiving assembly comprises a bridge member disposed above a base member to form an opening therebetween, the connector assembly being inserted, in use, into the opening on the front face of the receiving assembly.

The bridge member has a contact mounting surface on which are provided one or more electrical contacts. The electrical contacts are preferably resilient, e.g. so as to be biased into contact with the electrical contacts on the conductor when inserted into the receiving assembly. For example, in a preferred embodiment, the electrical contacts comprise generally parallel resilient loops, e.g. with a first linear segment coupled at one end to the first end of a second parallel linear segment. The first linear segment is preferably mounted to the contact mounting surface of the bridge member. The second end of the second linear segment preferably has a generally arcuate geometry, which preferably contacts and forms an electrical connection with a corresponding electrical contact on the connector. Alternatively, the second segment can have an angular or linear geometry as desired. The use of such resilient electrical contacts means that the electrical contacts of the receiving assembly will wipe along the electrical contacts of the connector each time the connector is inserted/removed, thereby cleaning dust and other similar debris from the surface of the contact.

Preferably the each electrical contact of the receiving assembly is inserted into a separate housing formed on the bridge member, e.g. to limit movement of the contacts and reduce the chances of adjacent contacts connecting and generating a short circuit. For example, in a preferred embodiment, the bridge member comprises one or more walls, each contact being mounted in the space between a pair of walls or between a wall and a side wall of the bridge member as appropriate.

The connector receiving assembly of the present invention comprises a latching member for engaging the connector when it is inserted into the opening formed between the base and bridge members. The latching member is configured to allow the connector assembly to be inserted into the opening, and then engage with the suitable structures on the connector to maintain the connector assembly in the opening, preferably once the connector has been fully (and correctly) inserted into the opening. Preferably, the latching member is further configured to be releasable such that, for example, when a predetermined removal force is applied to the connector then the latching member disengages from the connector, thereby allowing it to be removed from the opening.

In a preferred embodiment, the latching member comprises a plate that extends over the bridge and base members of the receiving assembly. This allows the provides the connector receiving assembly with a slim profile, thereby allowing the width of the electronic device (to which the assembly is mounted) to be reduced. For example, in a preferred embodiment, the latching member comprises a portion of an outer housing of the electronic device. In other words, the latching member preferably comprises a plate having two opposing faces, an outer face and an inner face, the inner face facing the guide surface of the base member.

The latching member is preferably attached to the assembly, and preferably to the rear of the bridge member, by a hinged or pivoted connection, e.g. such that the latching member can move away from the base member of the receiving assembly about the connection. For example, in a preferred embodiment, the latching member is attached to the bridge member by one or more pivot pins, e.g. with each pivot pin extending through an aperture in a side wall of the bridge member. The latching member preferably further comprises one or more lugs, which preferably project from the inner face of the latching member. The lugs are configured to engage with the stop shoulders of the connector assembly to prevent the connector being removed from the receiving assembly until a predetermined removal force is applied.

In a preferred embodiment, the one or more lugs comprise a chamfered or tapered surface. For example, the lugs preferably comprise a first bevelled surface (of increasing taper), which facilitates the lifting of the latching member as the connector is inserted into the opening in the receiving assembly, e.g. to allow the stop shoulders of the connector to being pushed past the lugs. The lugs preferably further comprise a second bevelled surface (of decreasing taper), which facilitates the lifting of the latching member as the connector is removed from the opening in the receiving assembly, e.g. to allow the stop shoulders of the connector to be pulled past the lugs as the connector is removed. The first bevelled surface is therefore formed on a front (outer) face of the lug or lugs, and the second bevelled surface is formed on a rear (inner) face of the lug or lugs.

The latching member is preferably biased in a “closed” position, e.g. wherein the plate of the latching member rests on an upper surface bridge member. The biasing can be provided using any suitable and desired means. For example, the hinged or pivoted connection of the latching member can be resilient, e.g. using one or more springs, or if the latching member is integrally formed with the bridge member by a living hinge.

As discussed above, the connector assembly is preferably formed at least in part from a magnetic material. In a preferred embodiment, the connector receiving assembly preferably further comprises a magnet for engaging with the connector assembly. The magnet (or magnets) is preferably positioned in the connector receiving assembly to engage with the connector assembly when it is fully inserted in the opening. For example, the magnet may be attached to the inner face of the latching member. The magnet, as will be appreciated, provides haptic feedback to the user as the connector is inserted into and removed from the opening, and can be used to control the force needed to be applied by the user to connector to remove it from the receiving assembly.

The connector receiving assembly can be of a unitary construction, e.g. such that the base member and bridge member are integrally connected. Alternatively, in other embodiments, the base and bridge members can be separate components connected together using any suitable means, such as an adhesive.

The present invention in accordance with any of its further aspects or embodiments may include any of the features described in reference to other aspects or embodiments of the invention to the extent it is not mutually inconsistent therewith.

Advantages of these embodiments are set out hereafter, and further details and features of each of these embodiments are defined in the accompanying dependent claims and elsewhere in the following detailed description.

### BRIEF DESCRIPTION OF THE DRAWINGS

Various preferred embodiments of the present invention will now be described, by way of example only, and with reference to the following figures, in which:

FIG. 1 is an exploded view of an exemplary electrical connection system for a portable electronic device including a mount in accordance with a first embodiment;

FIG. 2 is an exploded view of the mount and connector assembly according to the first embodiment;

FIG. 3 is a cross-sectional view of the connector assembly and the mount;

FIGS. 4A to 4E show some detail of a connector receiving assembly in an electronic device and corresponding connector assembly in the mount according to the first embodiment;

FIGS. 5A to 5C show some detail of a latching arrangement between the connector receiving assembly and the connector assembly in the mount according to the first embodiment;

FIGS. 6A to 6C provide different views of the connector assembly in the mount according to the first embodiment;

FIG. 7 is a perspective view of the connector assembly in an alternative mount according to a second embodiment of the present invention;

FIG. 8 is a perspective view of another exemplary electrical connection system for a portable electronic device including a mount according to a third embodiment;

FIG. 9 shows the connector assembly in accordance with the third embodiment;

FIGS. 10A and 10B provide side and bottom views of an exemplary connector receiving assembly in accordance with the third embodiment;

FIG. 11A shows a latch arrangement shared between the connector assembly and connector receiving assembly of the third embodiment;

FIG. 12 is a perspective view of another exemplary electrical connection system for a portable electronic device in accordance with a fourth embodiment;

FIG. 13 shows the connection system of FIG. 12 with the connector receiving assembly attached to a portable electronic device;

FIGS. 14A to 14C provide exploded views of the connection system of FIG. 12;

FIG. 15 is a perspective view of an exemplary connector assembly in accordance with the fourth embodiment;

FIGS. 16A and 16B provide examples of an electrical contact for the connector receiving assembly and the connector assembly, respectively, in accordance with the fourth embodiment; and

FIGS. 17A to 17C provide a front view, oblique view, and perspective view, respectively, of an exemplary connector receiving assembly in accordance with the fourth embodiment.

### DETAILED DESCRIPTION OF THE INVENTION

The present invention, at least in preferred embodiments, relates to an active dock that provides an electrical connection for portable electronic devices that may be removably connected to a mount, in particular to portable navigation devices (PNDs) that may be mounted to a windscreen or dashboard in a vehicle. It is an aim of the present invention to provide a compact and attractive mounting solution wherein a user can quickly dock a portable electronic device with only one hand, irrespective of the device's size or shape.

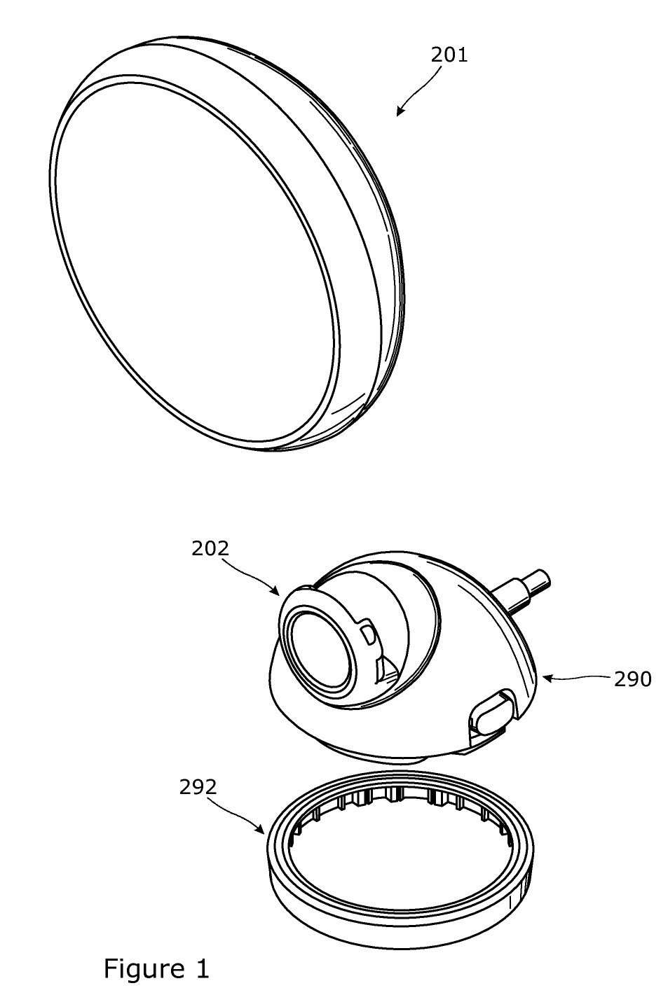

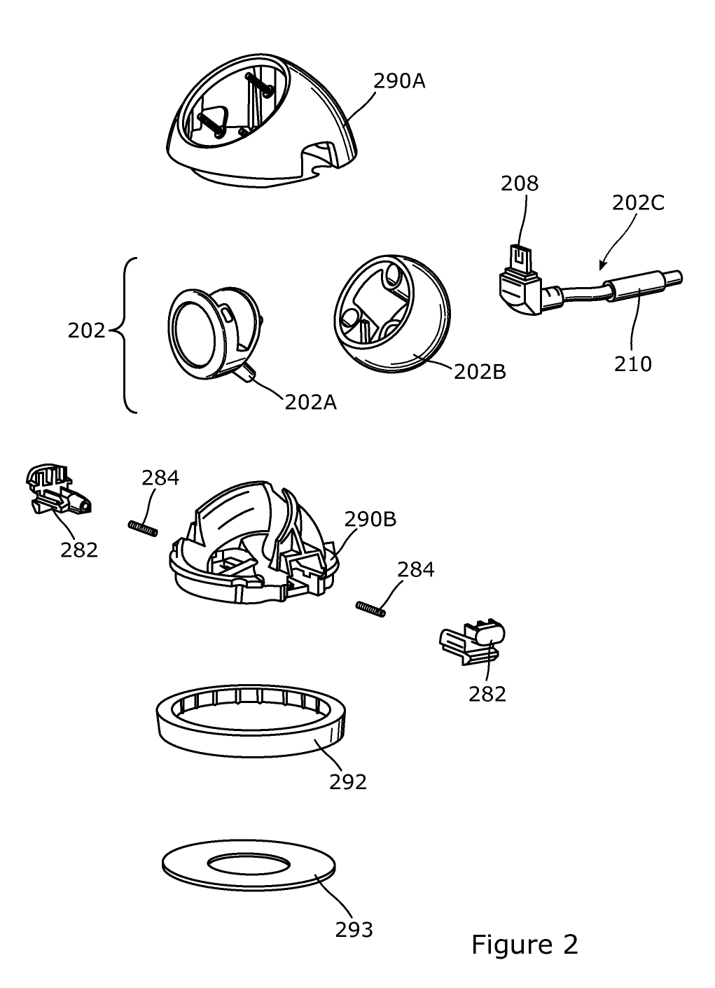

According to a first embodiment of the present invention, there is provided a connection system for connecting a portable navigation device 201 to a mount 290 as illustrated by FIGS. 1-7. The connection system comprises a connector assembly 202 attached to a mount 290, 290′ and a corresponding connector receiving assembly 206 that is provided on or in the portable electronic device 201. It may be generally seen from FIG. 1 that the portable electronic device 201 is docked onto the connector assembly 202 of a mount 290 that is provided with a mounting base 292, e.g. that can be adhesively attached to a dashboard or the like. The various components of the mount 290 and connector assembly 202 are shown in more detail in FIG. 2. The mount 290 comprises an upper mount cover 290A into which there is inserted a rotatable ball 290B and a ball support 290C. The connector assembly 202 comprises a support part 202A into which there is inserted a cable assembly 202B. The cable assembly 202B provides an electrical power connector 208 coupled to a cable 210. In the embodiment shown, the power connector 208 is a male micro-USB plug. The mount 290 is releasably connected to a base 292 that may be attached to a dashboard or other surface by an adhesive ring 293 provided on its underside. A pair of release buttons 282 are mounted by springs 284 on the ball support 290C so that a user can release the mount 290 from the base 292 as desired.

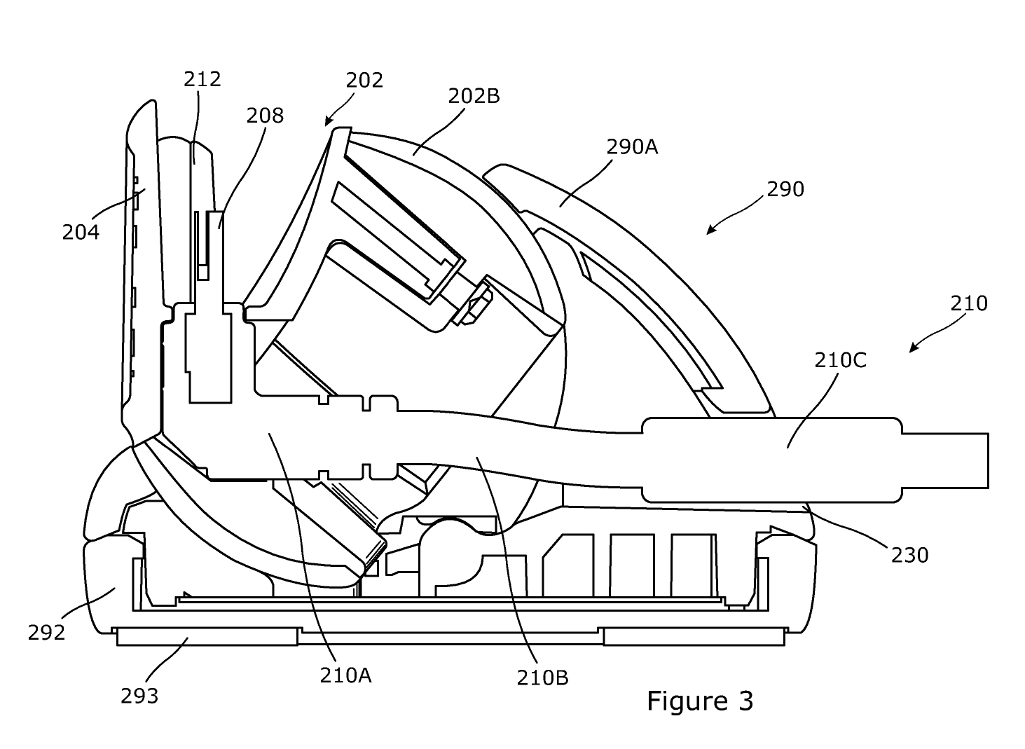

The mount 290 and connector assembly 202 are seen together in FIG. 3. In this embodiment, the connector assembly 202 is attached to a rotatable ball 290B that forms a ball and socket joint within the upper mount cover 290A. Rotation of the ball 290B is controlled by the ball support member 290C. Although this arrangement will not be described in further detail here, it will be understood that the ball 290B may be rotated within the ball and socket joint so that the connector assembly 202 can be oriented at different angles, both forwards and backwards and/or side to side, relative to the mount 290. It may also be seen from FIG. 3 that the power connector 208 is adjacent to a protruding support 204 that extends beyond the power connector 208 and can be inserted into a corresponding recess in the connector receiving assembly 206, as will be described in more detail below. Although in this embodiment the cable assembly 202B is a separate component that is attached to the support part 202A, it will be understood that the protruding support 204 of the support part 202A may instead be fixedly attached adjacent to the power connector 208 of the cable assembly 202B, e.g. by an integral plastics moulding. The power cable 210 extends in a direction away from the protruding support 204 and is led out of the mount 290 through an aperture at its rear to be connected to a suitable power source.

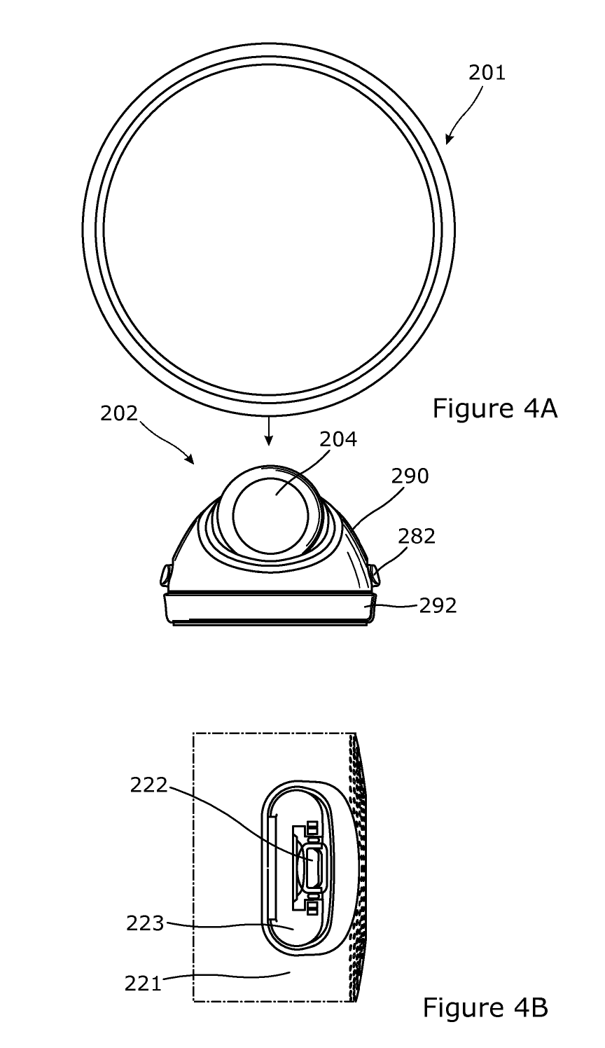

FIG. 4A provides a front view of a portable navigation device 201 being docked on to the electrical connector assembly 202 that is carried by the mount 290 seated on its base 292. FIGS. 4B and 4C show bottom and rear perspective views of the electronic device 201 and the electrical connector receiving assembly 206 formed within the housing 221 of the device 201. The connector receiving assembly 206 takes the form of a recess 223 that houses the device connector 222 and is arranged to receive the electrical connector assembly 202 in order to engage the device connector 222 with the corresponding power connector 208 to form an electrical connection for the device 201. FIGS. 4D and 4E provide top and side perspective views of the electrical connector assembly 202 in the mount 290. It can be seen that the protruding support 204 of the connector assembly 202 is generally U-shaped in cross-section with a pair of side walls 212 extending either side of the power connector 208 and defining a pair of longitudinal grooves 211 that extend substantially parallel to the electrical contacts of the power connector 208. The side walls 212 are connected by a support surface 214 that has a generally flat surface on a side facing the power connector 208 and curved edges such that the protruding mount 204 has a circular form but is lozenge-shaped in cross-section.

When the connector assembly 202 is engaged with the connector receiving assembly 206, the protruding mount 204 is inserted into the recess 223 while the power connector 208 is brought into engagement with the corresponding device connector 222. The side walls 212 and longitudinal grooves 211 in the protruding support 204 help to guide insertion of the support 204 so that the power connector 208 is aligned with the device connector 222. In this embodiment the device connector 222 is a female micro-USB socket. However, it will be appreciated that the plug and socket may of course be reversed. In order to accommodate the female socket 222 around the power connector plug 208, the support surface 214 and the side walls 212 are all spaced from the connector 208.

On the side of the support surface facing away from the power connector 208, the protruding support 204 is generally flat so as to co-operate with a corresponding flat inner surface of the recess 223 as the protruding support 204 is inserted therein. Similarly, the convex side walls 212 of the protruding support 204 co-operate with corresponding concave surfaces on the inside of the recess 223. These features all help to correctly align the connector assembly 202 as it is inserted into the receiving assembly 206. Once the protruding support 204 is inserted into the recess 223, it provides for a mechanical engagement in addition to the electrical connection of the power connector 208 with the device connector 222. This means that the rotatable ball 290B in the ball and socket joint of the mount 290 can be rotated so as to orient the connector assembly 202 at different angles and the weight of the electronic device 201 is supported by the connector assembly 202 without comprising the electrical connection. In particular, the protruding support 204 enables the electronic device 201 to be tilted backwards through a range of angles and/or rotated from side to side.

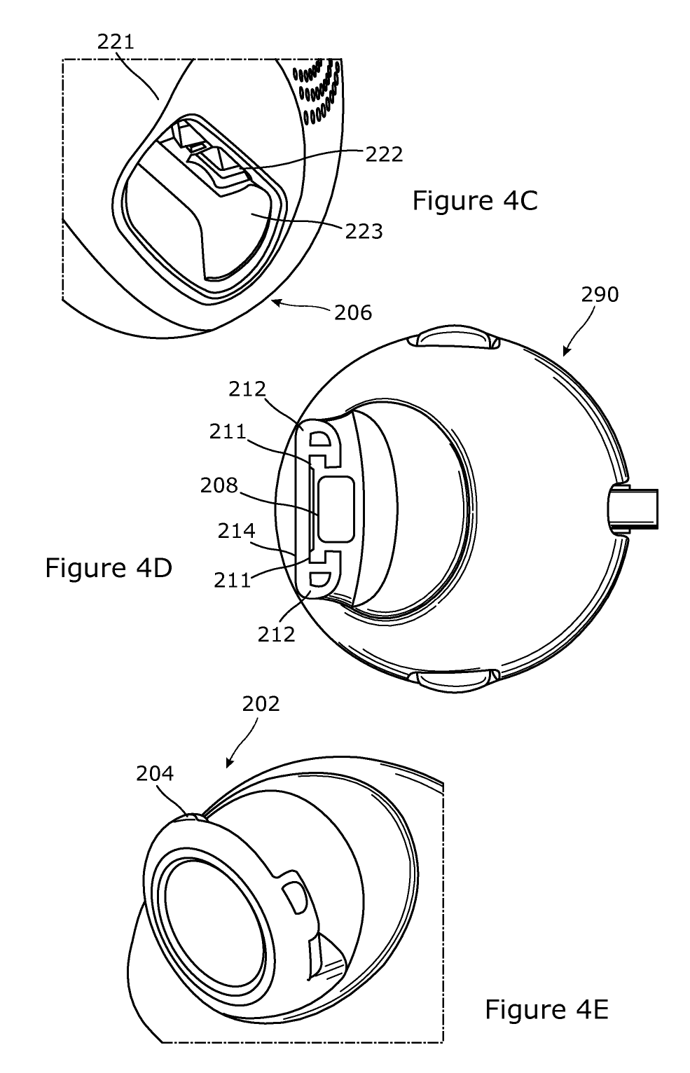

The connection system includes a latch arrangement that acts to releasably retain the protruding support 204 of the electrical connector assembly 202 within the connector receiving assembly 206 of an electronic device 201. The latch arrangement is illustrated in FIGS. 5A to 5C. Firstly, from the cut-away view shown in FIG. 5A it can be seen that the protruding support 204 comprises a support surface 214 extending substantially parallel to the power connector 208 and a pair of side walls 212 that extend transverse to the support surface 214, with the support surface 214 and the inner surfaces of the side walls 212 being spaced from the power connector 208 so as to provide a generally U-shaped support surrounding the power connector 208. The side walls 212 are each formed with a notch 220 that forms part of the latch arrangement. The pair of notches 220 are positioned so as to receive a corresponding part of the connector receiving assembly 206 in the manner shown in FIGS. 5B and 5C.

In this embodiment the latch arrangement is a resilient latch arrangement comprising a resilient member 224 provided in the connector receiving assembly 206. The resilient member 224 takes the form of a generally V-shaped spring that has a pair of spring legs 225 extending into the recess 223 so as to be insertable into the space surrounding the power connector 208 in the connector assembly 202 (i.e. the space defined inside the U-shaped support 204). When the spring 224 is relaxed, its legs 225 extend through openings in the inner surface of the recess 223 so as to be contacted by the sidewalls 212 of the protruding support 204 when it is inserted into the recess 223. As the protruding support 204 is pushed into the recess 223, the legs of the spring 224 are compressed towards one another so that the U-shaped support 204 fills the recess 223. The resilient force of the spring 224 causes the legs 225 to relax outwardly and engage inside the notches 220 formed in the side walls 212 of the protruding support 204. The connector assembly 202 is thereby retained within the connector receiving assembly 206 until a predetermined removal force is applied to overcome the spring bias and release the spring legs 225 from their engagement in the notches 220.

As will be appreciated, the spring 224 can be designed and constructed to provide a desired removal force. This may depend on factors including e.g. the size and/or weight of the portable electronic device 201 attached to the connector receiving assembly 206. Although in this embodiment a V-shaped spring 224 is shown, of course one or more helical springs could be used instead. Indeed the latch arrangement is not limited to one comprising a resilient member and any other suitable latch arrangement may be provided instead, or in addition, so as to provide a desired retaining force. An advantage of a resilient latch arrangement as is described above is that a user can simply grip the portable device 201 in one hand and pull it away from the electrical connector assembly 202 protruding from the mount 290 with sufficient force to overcome the resilient bias of the spring 224 and thereby release the connector receiving assembly 206. However, it is envisaged that the latch arrangement may use other, or additional, means to provide a retaining force that can be overcome by separating the connector receiving assembly 206 from the protruding support 204. For example, a magnetic retaining force may be employed.

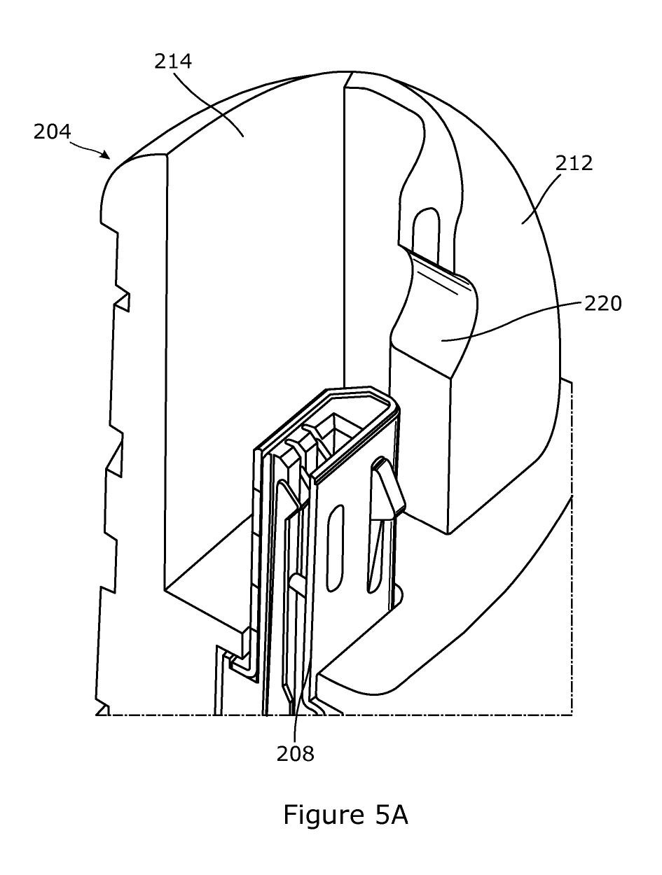

FIGS. 6A to 6C show the connector receiving assembly 202 and mount 290 in different positions. Depending on the orientation of the mount 290, a user may re-orient the connector assembly 202 as desired by rotating the ball 290B within the ball and socket joint of the mount 290. For example, in FIG. 6B the mount 290 is shown mounted horizontally onto a dashboard with the connector assembly 202 oriented substantially transverse to the base 292 so that an electronic device docked on the connector assembly 202 is oriented generally vertically. In FIG. 6C it is seen that the mount 290 may instead be mounted generally vertically and then the ball 290B may be tilted back into the mount cover 290A so that the connector assembly 202 is oriented substantially parallel to the base 292 and an electronic device 201 docked on the connector assembly 202 therefore remains vertical for ease of viewing. Of course, the connector assembly 202 may be oriented at various angles therebetween. It will be appreciated that reorientation of an electronic device 201 is facilitated by the protruding support member 204 of the connector assembly 202, which acts to support the weight of the electronic device 201 and provides for stable mounting regardless of its orientation.

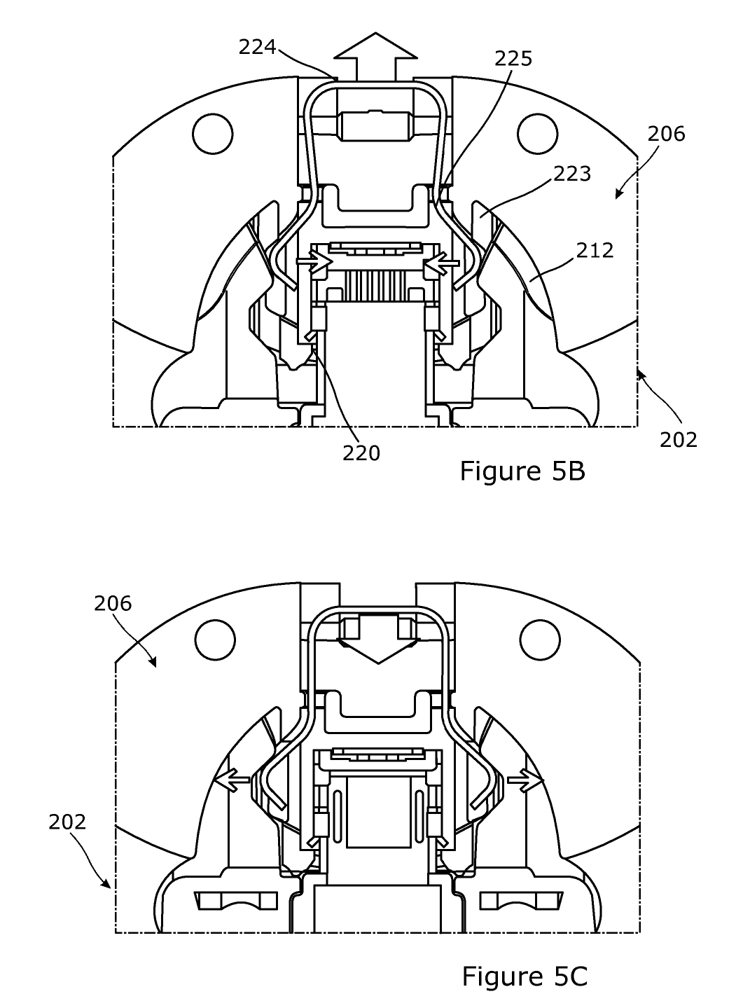

FIG. 7 shows an alternative type of mount 290′ according to a second embodiment that is intended to be mounted to a windscreen rather than to a dashboard. This alternative mount 290′ carries an electrical connector assembly 202 which is the same as described above, but may be fixedly or only rotatably attached to the alternative mount 290′ rather than attached by way of a fully articulated ball and socket joint.

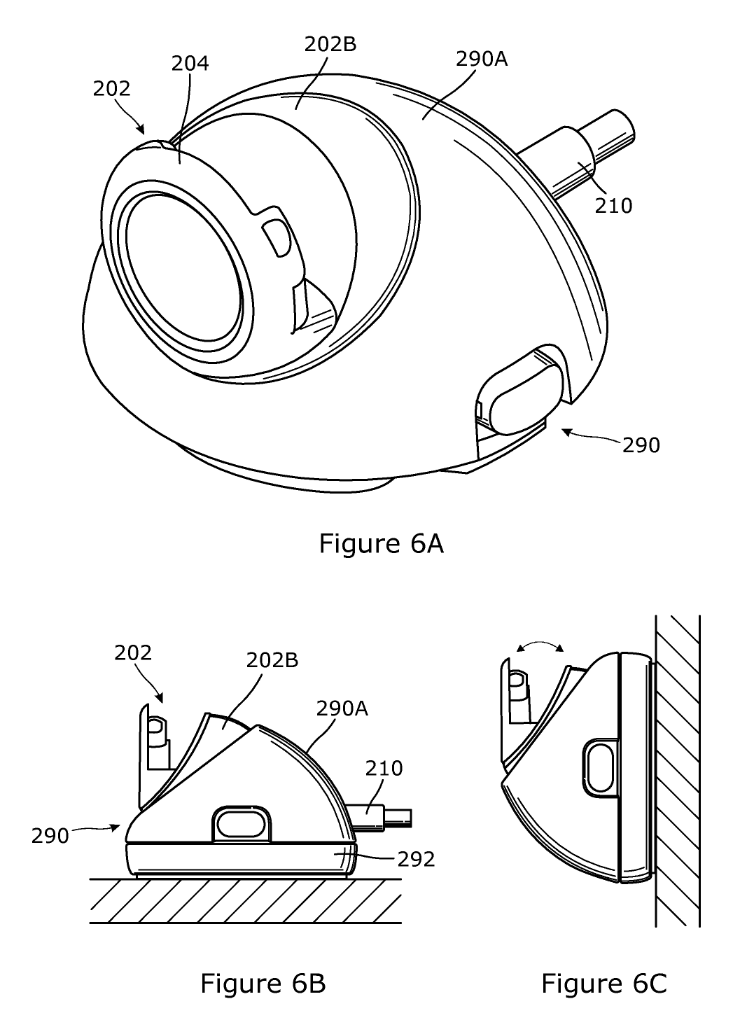

A third embodiment of a connection system for connecting a portable electronic device to a mount is shown in FIGS. 8 to 11. The connection system comprises a connector assembly 2 having an attachment means, in this case a ball joint 14 (to fit into a ball and socket joint), by which the connector assembly 2 can be attached to a mount (not shown). The connector assembly 2 is configured to be inserted into a connector receiving assembly 6. The connector receiving assembly 6 can be attached to or integrally formed with an electronic device (also not shown).

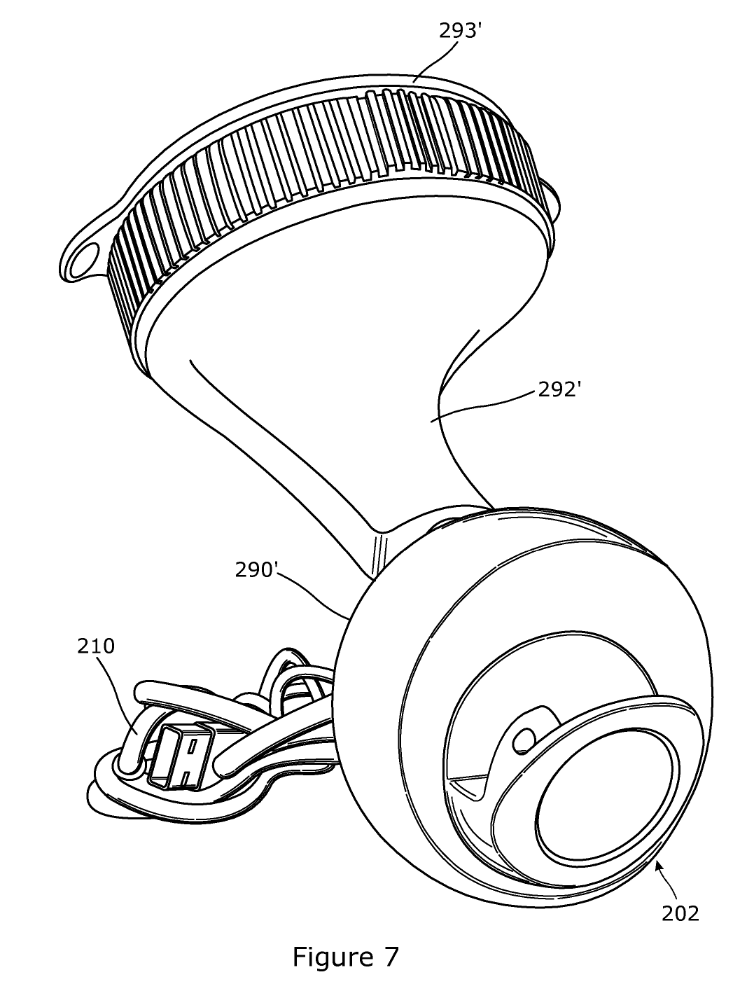

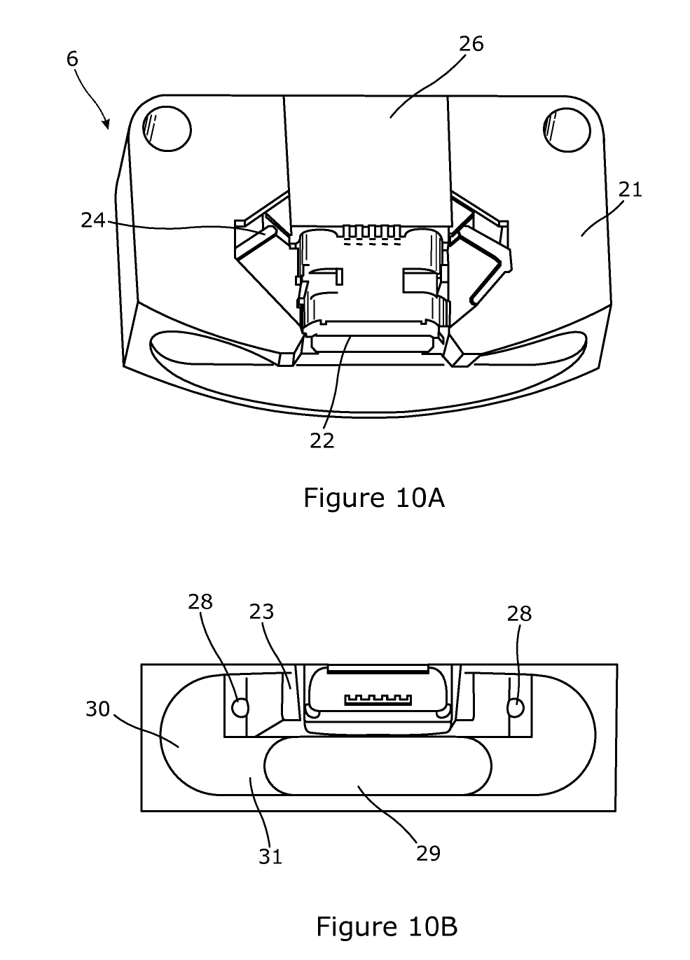

The connector assembly 2 is shown in detail in FIG. 9. The connector assembly 2 comprises a protruding support 4. At the sides of the support 4 are a pair of guide walls 12. Extending between the pair of guide walls 12 from an opening in the rear of the assembly is a power connector 8, which in the embodiment shown is a male micro-USB plug. As can be best seen in FIG. 11a, the USB plug 8 is partially located and supported within a hollow portion 32 of the connector assembly 2. An electrical cable 10 passes through another opening in the hollow portion 32 and is soldered to the USB plug to provide for the transfer of power and/or data to and from the mount. Formed in each of the guide walls 12 is a notch 20. The function of this notch will be discussed in more detail below.

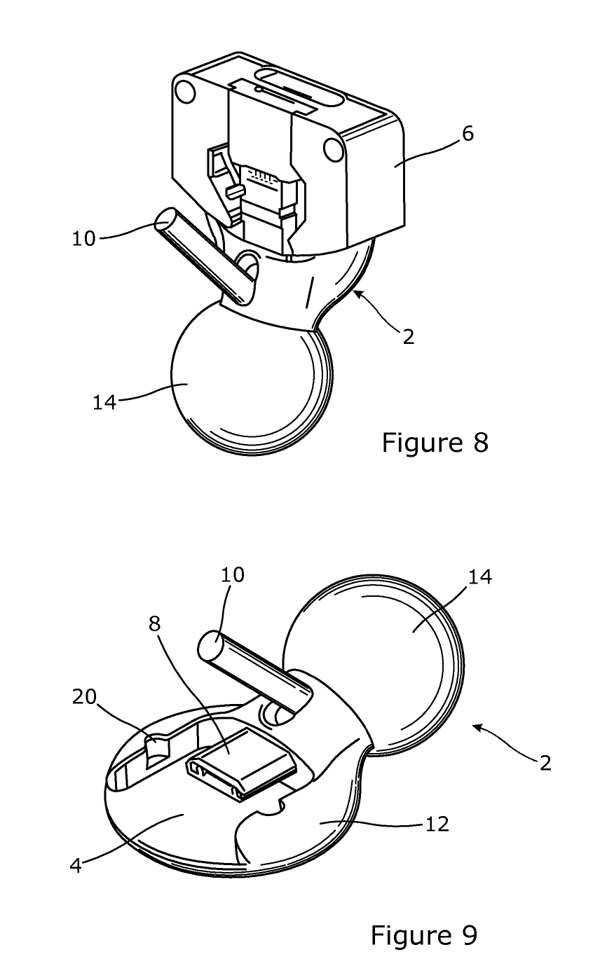

The connector receiving assembly 6 is shown in detail in FIGS. 10A and 10B. The receiving assembly 6 comprises a housing 21 having a central recess 23 in its upper surface. The recess 23 supports a device connector 22, which in the embodiment shown is a female micro-USB socket, and which is located at the front of the receiving assembly 6. A latching assembly is also supported by the recess 23 of the housing 21 and is located behind the device connector 22. The latching assembly is arranged to releasably retain the connector assembly 2 to hold the connector assembly 2 in the correct position, i.e. with the USB plug being suitable located within the USB socket.

The recess 23 in the housing defines a pair of side channels 30 and a bottom channel 31. As will be appreciated, the side channels 30 are arranged to receive the guide walls 12 of the protruding support 4 and the bottom channel 31 is arranged to receive and guide the connector assembly 2.

The latching assembly comprises a spring 24 that is biased against a retainer 26. The retainer 26 can be integrally formed with the housing 21 or be provided as a separate component. The spring 24 is V-shaped and has two contact portions 28 which, when the spring 24 is relaxed, extend through openings in the housing 21 into the recess 23 (as best shown in FIG. 10B). The contact portions 28 are arranged to engage with the notches 20 in the side walls 12, e.g. as shown in FIG. 11B, to maintain the connector assembly 2 within the receiving assembly 6 until a predetermined removal force is applied. In another embodiment (not shown), a pair of helical springs could be used instead of the spring 24. As will be appreciated, the connector assembly 2 and the receiving assembly 6 are shaped to guide the connector assembly 2 into the correct position in the receiving assembly 6. For example, the substantially flat face of the protruding support 4 cooperates with a substantially flat inner surface of the recess 23. Similarly, the convex sides of the protruding support 4 and guide walls 12 (as can be seen in FIG. 9) cooperate with the concave surfaces at the sides of the recess 23. In addition, the front of the receiving assembly 6 is curved in a convex manner to help correctly align the connector assembly 2 as it is pushed into the receiving assembly 6. This can best be seen in FIG. 10A.

The connector assembly 2 is inserted by a user into the receiving assembly 6. As the connector assembly 2 is pushed further into the recess 23, the USB plug 8 is pushed into the USB socket 22 and the spring 24 is compressed by the guide walls 12 of the connector assembly 2. Simultaneously with the mating engagement of the USB plug and socket 8, 22, the notches 20 in the guide walls 12 are coincident with the contact portions 28 of the spring 24, and the spring 24 is therefore allowed to return to its relaxed position. The contact portions 28 thus engage with the notches 20 thus locking the connector assembly 2 into the receiving assembly 6. In this position, the front of the connector assembly 2 extends through an opening 29 in the rear of the receiving assembly 6. The additional contact between the edges of the opening 29 and the protruding support 4 provides further support to the connector assembly 2 when it is positioned in the receiving assembly 6.

When a predetermined removal force is applied to the connector assembly 2, the spring 24 is again compressed and the contact portions 28 disengage from the notches 20. As will be appreciated, the spring 24 can be designed and constructed to provide a desired removal force.

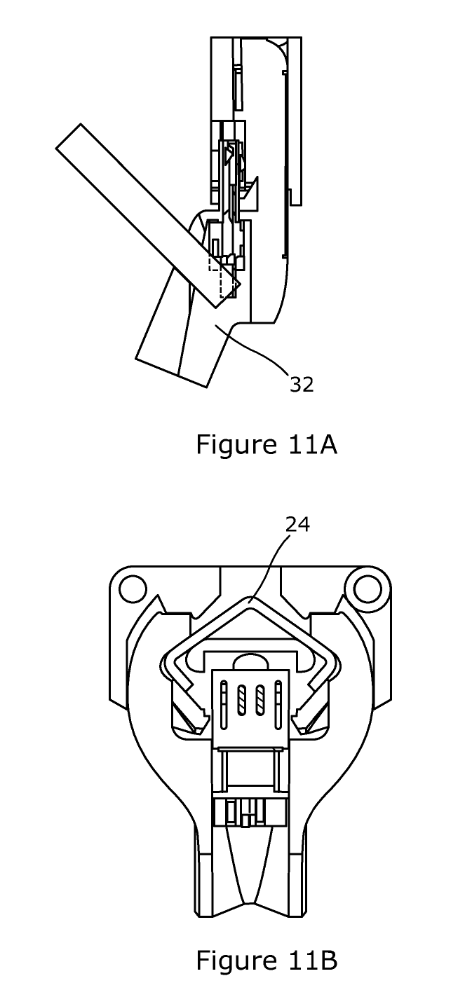

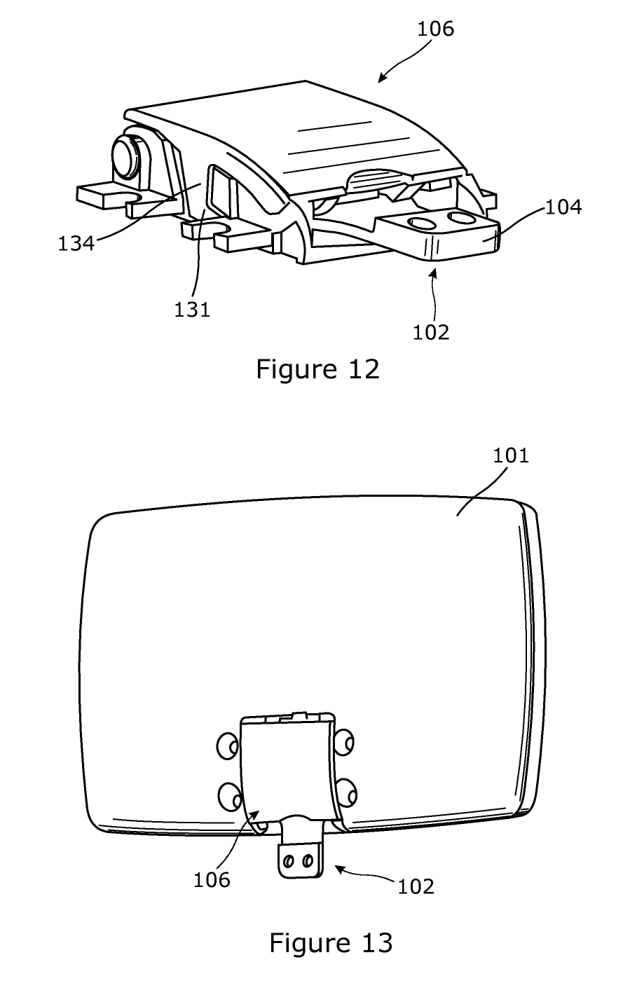

A fourth embodiment of a connection system for connecting a portable electronic device to a mount is shown in FIGS. 12-17. The connection system comprises a connector 102, which is attached to a mount (not shown) by attachment means 104, and which is configured to be inserted into a connector receiving assembly 106. As shown in FIG. 13 the connector receiving assembly 106 is configured to be attached to or integrally formed with an electronic device 101.

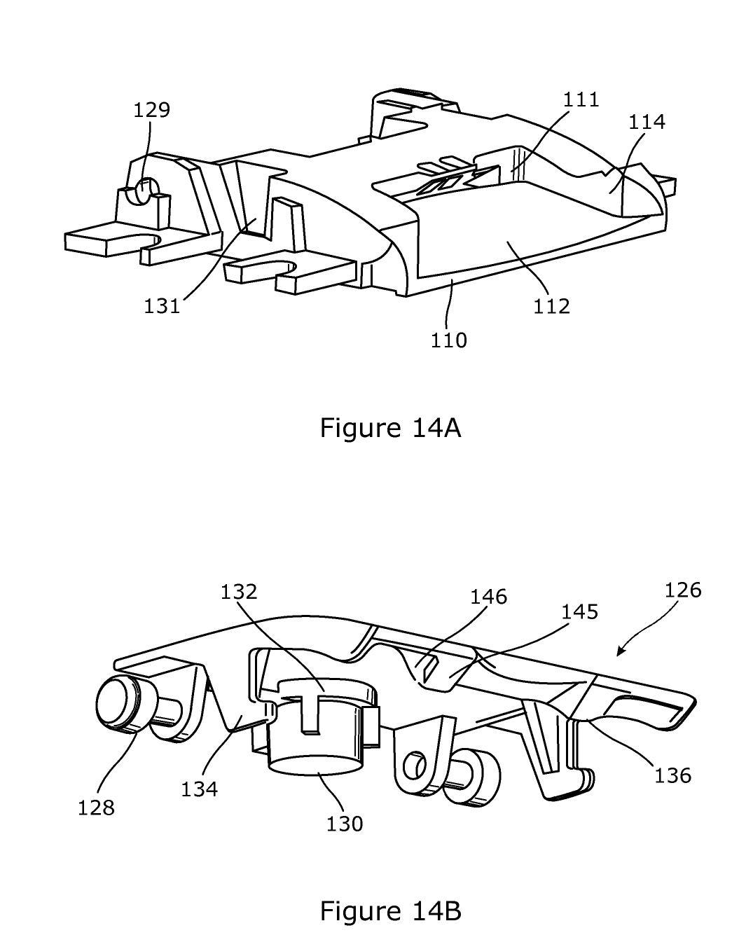

An exploded view of this connection system is shown in FIGS. 14A, 14B and 14C, wherein FIGS. 14A and 14B show the lower and upper parts of the connector receiving assembly 106, and FIG. 14C shows the connector assembly 102.

The connector assembly 102 comprises a substantially circular metallic plate 140 on which are mounted a plurality of electrical contacts 160.

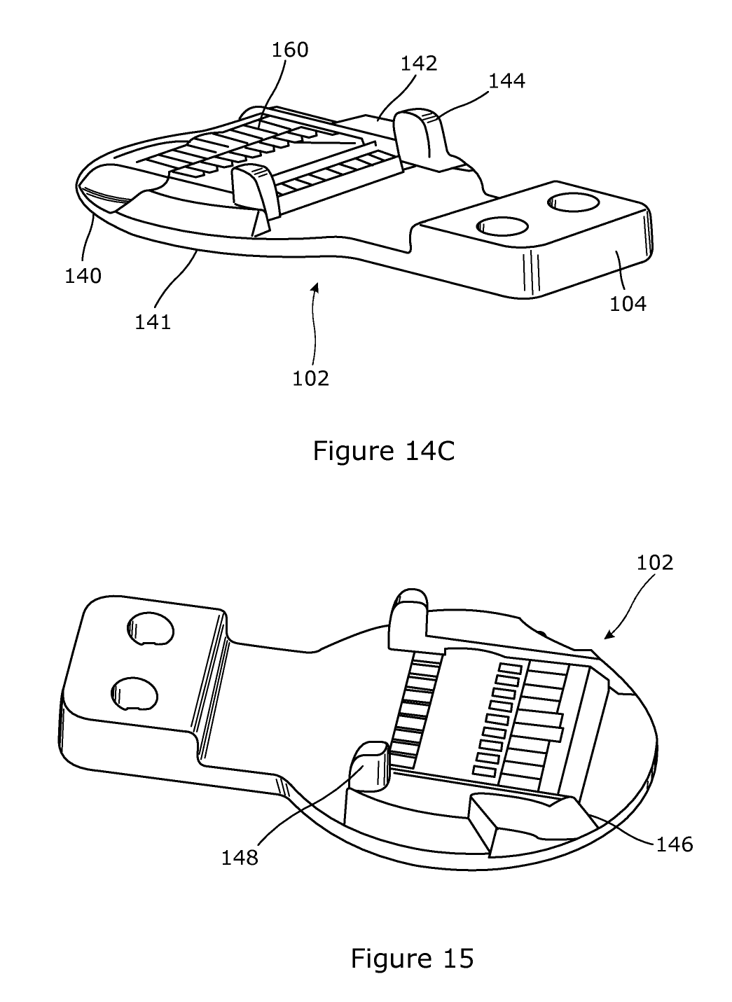

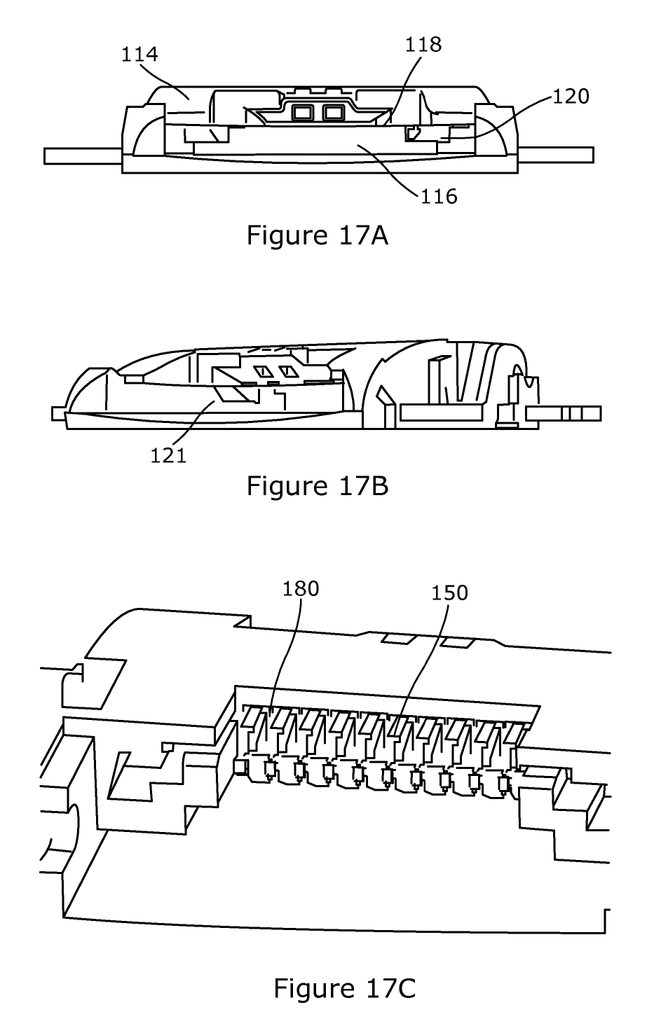

The connector receiving assembly 106 comprises a base member 110 and a bridge member 114, the bridge member 114 extending over the base member 110 to form an opening 116 therebetween for receiving the connector assembly 102. The flat upper surface 112 of the base member 110 forms a guide surface along which the flat bottom surface 141 of the connector assembly 102 travels as it is inserted into the opening 116. The bridge member 114 further comprises a pair of raised surfaces 120 that extend into the opening 116 (see FIG. 17A), and which act to correctly align the connector assembly 102 in the receiving assembly 106. In particular, and as shown in FIG. 17B, the front face 121 of each raised surface 120 is tapered. These tapered surfaces cooperate with similar tapered surfaces 146 on the connector assembly 102 (see FIG. 15) to push the connector assembly 102 to the bottom of the receiving assembly 106.

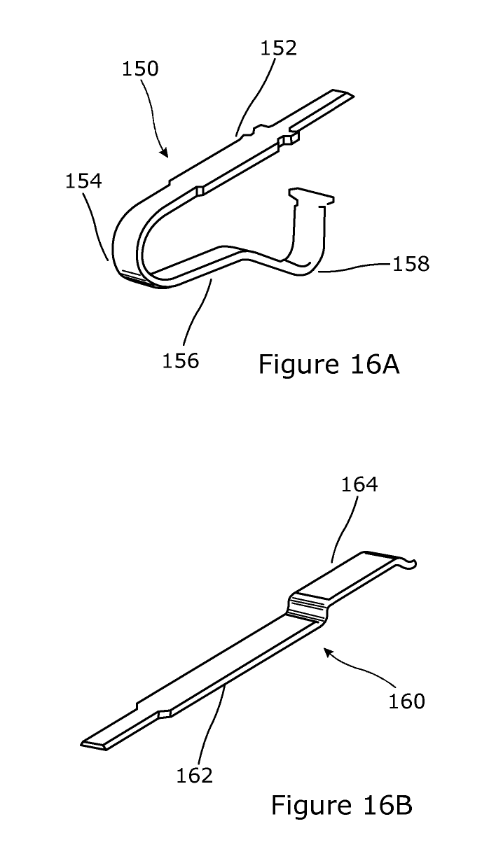

A plurality of resilient electrical contacts 150 are attached to the bridge member 114 (on a contact mounting surface 118) and extend into the opening 116. As can be seen in FIG. 10, the electrical contacts 150 are each contained between walls 180 of the bridge member 114 to prevent the contacts touching each other (thereby potentially causing a short circuit) as the connector assembly 102 is inserted. A contact 150 is shown in FIG. 16A to comprise a first straight section 152 connected by an arcuate head portion 154 to a second straight section 156 running in parallel to the first straight section 152. At the end of the second straight section 156 is a contact section 158 having an arcuate geometry. The bottom of the contact section 158 stands proud to contact corresponding contacts 160 on the connector assembly 102 to form an electrical connection to allow power and/or data to be transferred between a mount and a portable electronic device.

A contact 160 of the connector assembly 102 is shown in FIG. 16B to comprise a straight section 162 and a raised section 164. The section 164 is biased in an upwards direction, and is depressed by a corresponding resilient contact 150 to cause a reliable connection between the pairs of contacts. The flexible nature of the contacts 150 allow them to wipe the surface of the corresponding contacts 160 as the connector assembly 102 is inserted and removed, resulting in the removal of dust and other surface debris which tends to form over time.

As shown in FIGS. 14C and 15, the contacts 160 of the connector assembly 102 are positioned between a pair of raised surfaces 142. The surfaces 142 are configured to travel along the surfaces 120 of the receiving assembly 106 to correctly align the connector assembly 102 therein. At the end of each surface 142 is a stop shoulder 144, which limits how far the connector assembly 102 can be pushed into the receiving assembly 106 by coming into contact with an abutment surface 111 of the bridge member 114 (see FIG. 14A). The stop shoulders 144 also act to correctly align the connector assembly 102 in the opening when it is inserted at an incorrect angle. For example, as will be appreciated, if the connector assembly 102 is inserted into the opening such that one of the shoulders 144 contacts the abutment surface 111 before the other, then the circular shape of the connector assembly 102 allows the connector to rotate until both shoulders 144 contact the abutment surface 111 bringing the electrical contacts 150, 160 into the correct alignment.

Positioned over the upper surface of the bridge member 114 is a latching member 126, which acts to maintain the connector assembly 102 in the receiving assembly 106. The latching member 126 is pivotally attached at the rear of the bridge member 114 by means of a pair of pivot pins 128, which extend through openings 129 in the bridge member 114. The movement of the latching member 126 about the pivot is limited due to the interaction between the stop 131 on the bridge member 114 (seen best in FIG. 12) and a sidepiece 134 on the latching member 126.

Along the front edge of the latching member 126 are a pair of lugs 136, which cooperate with the shoulders 144 on the connector assembly 102 as discussed in more detail below. As shown in FIG. 14B, the lugs 136 have a front bevelled surface 145 and a rear bevelled surface 146. These bevelled surfaces cooperate with shoulders 144 on the connector assembly 102 to lift the latching member 126 as the connector assembly 102 is inserted and removed from the receiving assembly 106. The shoulders 144 have a curved surface 148 (as shown in FIG. 10) to facilitate the lifting of the latching member 126. In addition, at the rear of the latching member 126 is a magnet 130, which is contained within a cage structure 132.

As the connector assembly 102 slots into the opening 116 of the receiving assembly 106, the surfaces 142 of the connector assembly 102 will travel along the guide surfaces 120 to push the connector assembly 102 to the base of the receiving assembly 106. The connector assembly 102 will continue to move into the opening until one or both of the shoulders 144 mates with the abutment surface 111. In the event only one shoulder 144 hits the abutment surface 111, the connector assembly 102 will pivot about the mating shoulder 144 (due to the shape of the connector) until the other shoulder 144 also contacts the abutment surface. When the shoulders 144 of the connector assembly 102 contact the abutment surface 111, a connection is made between the electrical contacts 150 and 160 of the connector assembly 102 and receiving assembly 106. The latching member 126, which was previously lifted as the shoulders 144 moved under the lugs 136, also falls back to its original position (resting on the upper surface of the bridge member 114) with the inner surface 146 of the lugs 136 acting as a stop to restrict removal of the connector assembly 102 from the receiving assembly 106. The connector assembly 102 is also maintained in the receiving assembly 106 by means of the magnet 130, which attracts the metallic material of the connector assembly 102.

As will be appreciated, when a user wishes to undock the electronic device, the device is pulled with sufficient force to break the connection between the magnet 130 and connector 102. Pulling the receiving assembly 106 away from the connector assembly 102 also releases the latching member 126.

An electrical connection system according to embodiments of the present invention is particularly suited to mounting portable devices, such as portable navigation devices, with touch screens which may be configured to execute location-based software so as to provide one or more functions, such as route planning, destination information, traffic information, real-time traffic updates, estimated time of arrival, alternative route suggestions, favourite destinations, navigation, etc.

It will be appreciated, however, that the electrical connection systems described herein can be used with any type of portable electronic device, such as a portable personal computer, mobile telephone, smart phone, PDA, portable audio system (e.g. radio player, MP3 player), multi-media player, games console or tablet computer.

As will be appreciated by those skilled in the art, various changes and modifications can be made to the above described embodiments whilst still falling within the scope of the present invention as set forth in the accompanying claims.

1. An electrical connector assembly to support and form an electrical connection with a portable electronic device, the electrical connector assembly comprising:
a power connector having one or more electrical contacts to deliver electrical power to a portable electronic device when the power connector is engaged with a corresponding device connector in an electrical connector receiving assembly of the electronic device; and
a protruding support for the electronic device that is insertable into a recess in the connector receiving assembly in order to engage the power connector with the corresponding device connector, the support comprising a support surface extending in a plane substantially parallel to the one or more electrical contacts of the power connector, and a pair of side walls each having an inner surface extending in a plane substantially transverse to the support surface,
wherein at least one of the support surface and the inner surfaces of the side walls is spaced from the power connector and formed with part of a latch arrangement that receives a corresponding part of the connector receiving assembly to releasably retain the protruding support within the connector receiving assembly.

2. The electrical connector assembly of claim 1, wherein the support protrudes from the electrical connector assembly beyond the power connector.

3. The electrical connector assembly of claim 1, wherein the inner surfaces of the side walls are each provided with a longitudinal groove extending substantially parallel to the one or more electrical contacts of the power connector.

4. (canceled)

5. The electrical connector assembly of claim 1, wherein the side walls have a curved outer surface.

6. The electrical connector assembly of claim 1, wherein the power connector is spaced from the inner surfaces of the side walls

7. The electrical connector assembly of claim 1, wherein both inner surfaces of the side walls are formed with part of the latch arrangement.

8. The electrical connector assembly of claim 1, wherein the power connector is spaced from the support surface between the side walls.

9. (canceled)

10. The electrical connector assembly of claim 1, further comprising an electrical cable coupled to the power connector so as to extend in a direction away from the protruding support.

11. The electrical connector assembly of claim 1, wherein the latch arrangement provides a retaining force that can be overcome by separating the connector receiving assembly from the protruding support.

12. (canceled)

13. The electrical connector assembly of claim 1, wherein at least one surface of the protruding support is formed with a retaining profile for a resilient member provided by the connector receiving assembly.

14. The electrical connector assembly of claim 13, wherein both inner surfaces of the pair of side walls are formed with retaining profiles.

15. An electrical connector receiving assembly of or for an electronic device, the electrical connector receiving assembly comprising:
a device connector having one or more electrical contacts arranged to receive electrical power when the device connector is engaged with a corresponding power connector provided by an electrical connector assembly; and
a recess that houses the device connector and is arranged to receive the electrical connector assembly in order to engage the device connector with the corresponding power connector to form an electrical connection for the electronic device, wherein the recess defines a channel extending in a plane substantially parallel to the one or more electrical contacts of the device connector, and
wherein part of a latch arrangement is provided at an inner surface of the recess so as to be insertable into a corresponding space in the electrical connector assembly to thereby releasably retain the electrical connector assembly in the recess.

16. The electrical connector receiving assembly of claim 15, wherein the recess defines a generally U-shaped or semi-circular channel surrounding the device connector.

17. (canceled)

18. The electrical connector receiving assembly of claim 15, wherein the part of the latch arrangement provided at an inner surface of the recess comprises at least one resilient member.

19. The electrical connector receiving assembly of claim 18, wherein the at least one resilient member is arranged to extend from an inner surface of the recess into the recess when it is in a relaxed position.

20. (canceled)

21. The electrical connector receiving assembly of claim 18, wherein the at least one resilient member comprises a spring.

22. A portable electronic device comprising an electrical connector receiving assembly as claimed in claim 15.

23. The portable electronic device of claim 22, wherein the one or more electrical contacts of the device connector in the connector receiving assembly are connected to a printed circuit board (PCB) of the electronic device for electronic communication therebetween.

24. (canceled)

25. (canceled)

26. A mounting apparatus for a portable electronic device, comprising an electrical connector assembly according to claim 1.

27. The mounting apparatus of claim 26, wherein the electrical connector assembly is insertable into a recess in a connector receiving assembly of the electronic device.
